(19) United States
(12) Patent Application Publication
(10) Pub. No.: US 2007/0030924 A1
(43) Pub. Date: Feb. 8, 2007

(54) An Iterative Frequency Offset Estimator for PSK Modulation

(75) Inventor: Xiaoming Yu, Cupertino, CA (US)

Correspondence Address: FELIX L. FISCHER, ATTORNEY AT LAW, 1607 MISSION DRIVE, SUITE 204, SOLVANG, CA, 93463, US

(73) Assignee: UTStarcom. Inc., Alameda, CA (US)

(21) Appl. No.: 11/380,885

(22) Filed: Apr. 28, 2006

Related U.S. Application Data
(63) Continuation-in-part of application No. 11/196,233, filed on Aug. 2, 2005.

(51) Int. Cl. H04L 27/22

(52) U.S. Cl. 375/332

(57) ABSTRACT

A method for non-data aided frequency offset determination for MPSK demodulation is accomplished by receiving a stream of K symbols and providing the symbol stream to a delay line of L symbols in length with L greater than 1. The symbol stream and an output of the delay line is taken at each increment of L and then multiplied and the output of the multiplier is raised to the M power to remove modulation. The result is accumulated over K symbols and the argument of 1/K2πMLT times the accumulated result is determined as a frequency offset. L is then incremented and the calculation repeated. The calculated frequency offsets are then summed for a final frequency offset determination.

### REFERENCE TO RELATED APPLICATIONS

This application is a continuation-in-part of U.S. patent application Ser. No. 11/196,233 filed on Aug. 2, 2005 entitled A HIGH ACCURACY NON DATA-AIDED FREQUENCY ESTIMATOR FOR M-ARY PHASE SHIFT KEYING MODULATION having a common assignee as the present invention.

### BACKGROUND OF THE INVENTION

1. Field of the Invention

This invention relates generally to the field of telecommunications network transmission systems and, more particularly, to a non-data-aided iterative frequency estimator for use in demodulation of M-ary phase shift keying (M-PSK) modulated signals.

2. Description of the Related Art

M-ary phase shift keying (M-PSK) modulation is widely used in communication systems. Among the most widely used M-PSK modulation schemes are binary phase shift keying (BPSK), quadriphase shift keying (QPSK), and their variations such as π/4 QPSK, differential QPSK. A representative explanation of these systems is disclosed in Y. Okunev, Phase and Phase-difference Modulation in Digital Communications, Artech House, 1997

For current exemplary systems, the second generation CDMA system uses BPSK while the third generation WCDMA system uses both BPSK and QPSK modulation. The PHS system uses π/4 differential QPSK.

It is often impractical or economically infeasible to maintain exact frequency synchronization between the transmitter and the receiver, as a result, accurate frequency estimation of the difference between the transmitted and received signals is desirable. This is especially true for coherent demodulation, for which highly accurate estimation is essential. Most prior art systems employ data-aided frequency estimation using training sequences embedded in message bursts. However, this technique uses bandwidth and may require additional complexity in the demodulation algorithms and hardware.

It is therefore desirable to provide non-data-aided frequency estimator for M-PSK demodulation with increased accuracy.

### SUMMARY OF THE INVENTION

The present invention provides a method for non-data aided iterative frequency offset determination for MPSK demodulation accomplished by receiving a stream of K symbols and providing the symbol stream to a delay line of L symbols in length with L greater than 1. The symbol stream and an output of the delay line are then multiplied and the output of the multiplier is raised to the M power to remove modulation. The result is accumulated over K symbols and the argument of 1/K times the accumulated result is determined as the frequency offset. At a first increment, a frequency offset is determined for L=1. This offset is then removed in a second iteration for L=2 to provide a second frequency offset estimation. The process is iterated for selected values of L up to L−1 with each subsequent frequency offset removed for the next iteration and each of the calculated frequency offsets summed to provide a final frequency offset output.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements acting on a symbol input stream for each iterative element of an embodiment of the invention;

FIG. 2 is a block diagram of an exemplary hardware implementation of the embodiment of FIG. 1; and,

FIG. 3 is a block diagram of the iterative elements of FIG. 1 to create a system according to the present invention.

### DETAILED DESCRIPTION OF THE INVENTION

This invention applies to all types of MPSK modulation. In what follows, it is described using a MPSK modulation signal model.

Each symbol of a received M-PSK signal can be described in baseband complex format by the following equation:
S(k)=Cₖe^{j2π(f}^{_{c}}^{+f}^{₀}^{)kT+θ}+n(k) (1)

Where k represents the sample index and k=0, 1, . . . K. f_{c} and f₀ are the carrier frequency and frequency offset respectively. T is the symbol duration. θ is the phase offset. n(k) is the white Gaussian noise, Cₖ is the data symbol belonging to the MPSK constellation

$${C}_{k} = {ⅇ}^{j \frac{2 πⅈ}{M}} \qquad ( 2 )$$

where 0≦k≦M−1

Many frequency estimation techniques have been developed for MPSK. Most are data-aided, i.e., some sort of training sequence is transmitted in addition to the information. On the receiver side, the known training sequence is used to estimate frequency offset.

Non-data aided frequency estimation does not need a training sequence. It takes into account of the fact that (Cₖ)^{M}=1 to effectively remove the modulation from a M-PSK signal. The modulation removed M-PSK signal can then be used for frequency estimation. Frequency estimation methods based on this concept are called none-data-aided frequency estimators. A non-data aided frequency offset estimator is highly desirable since it has high bandwidth efficiency due to the fact that it eliminates the need for a training sequence.

One commonly used non data-aided frequency estimation method for M-PSK is proposed in J Chuang and N Sollenberger, Burst Coherent Demodulation with Combined Symbol Timing, Frequency Offset Estimation, and Diversity Selection, IEEE trans. Communications, pp 1157-1164, July 1991, which is described below.

Raising Equation (1) to the Mth power yields
[S(k)]^{M}=e^{j[2π(f}^{_{c}}^{+f}^{₀}^{)kT+θ]M}+n′(k) (3)
n′(k) is the noise term resulting from signal multiplied by noise and noise multiplied by noise. Modulation is removed in the equation. Next, multiplying [S(k)]^{M} by [S(k−1)]^{M}, provides
[S(k)]^{M}·[S*(k−1)]^{M}=e^{j2πMf}^{₀}^{T}+n″(k) (4)

Again n″ (k) is the noise term resulting from signal multiplied by noise and noise multiplied by noise.

It is apparent that carrier frequency and phase are removed in Equation (4) so it can be used to estimate f₀. The estimation accuracy can be further improved by smoothing out the noise

$$\frac{1}{K} {\sum }_{k = 0}^{K - 1} ( {[ S ( k ) ]}^{M} \cdot {[ {S}^{*} ( k - 1 ) ]}^{M} ) = {ⅇ}^{j2π {Mf}_{0} T} + \frac{1}{K} {\sum }_{k = 0}^{K - 1} {n}^{″} ( k ) \qquad ( 5 )$$

In summary the frequency estimator is

$${f}_{0} = \frac{1}{2 π MT} arg \{ \frac{1}{K} {\sum }_{k = 0}^{K - 1} ( {[ S ( k ) ]}^{M} \cdot {[ {S}^{*} ( k - 1 ) ]}^{M} ) \} \qquad ( 6 )$$

The estimator described above is good for applications where moderate accurate frequency estimation is required such as differential PSK. However, for application where more accurate estimation is needed, such as coherent demodulation of M-PSK signal, it is not accurate enough.

A new frequency estimator, which is capable of estimating very small frequency offset is created by replacing S(k) and S(k−1) with S(k) and S(k−L), where L is larger than 1. The use of S(k) and S(k−L), when L is large, enables estimation of small frequency errors since the phase offset is accumulated over L symbol periods to 2πf₀LT instead of 2πf₀T.

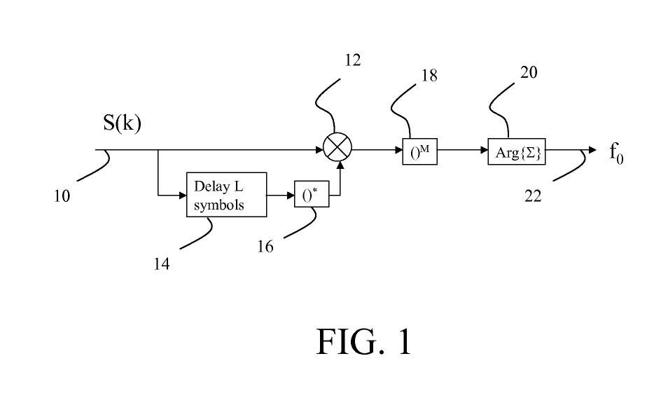

As shown in FIG. 1, the symbol input stream S(k) 10 is routed to a multiplier 12 and through delay line of up to L symbols 14 and conjugated 16. The delayed signal is multiplied and the result is raised to the M power in multiplier 18 [S(k)]^{M} times [S(k−L)]^{M}, to provide
[S(k)]^{M}·[S*(k−L)]^{M}=e^{j2πMLf}^{₀}^{T}+n″(k) (7)
where n″ (k) is the noise term resulting from signal multiplied by noise and noise multiplied by noise.

Similar to Equation (4), we can use Equation (7) to estimate f₀. The estimation accuracy can be further improved by smoothing out the noise as well

$$\frac{1}{K} {\sum }_{k = 0}^{K - 1} ( {[ S ( k ) ]}^{M} \cdot {[ {S}^{*} ( k - L ) ]}^{M} ) = {ⅇ}^{j2π {Mf}_{0} T} + \frac{1}{K} {\sum }_{k = 0}^{K - 1} {n}^{″} ( k ) \qquad ( 8 )$$

The offset frequency is then estimated as

$${f}_{0} = \frac{1}{2 π MLT} arg \{ \frac{1}{K} {\sum }_{k = 0}^{K - 1} ( {[ S ( k ) ]}^{M} \cdot {[ {S}^{*} ( k - 1 ) ]}^{M} ) \} \qquad ( 9 )$$

An initial frequency offset 22 is obtained by operating on the output of the exponent multiplier with ½πMLT times the argument of 1/K times the sum over K symbols in accumulator 20. The frequency offset determination is usually accomplished for each burst. Frequency change during each burst is usually very small, however, should situations arise where frequency change is anticipated during symbol bursts, this method can be used multiple times during a burst.

The performance of this frequency estimation method depends on K, the number of samples, as well as the interval between the adjacent samples. The estimator of the present invention collapses to the estimator described in Chuang and Sollenberger by letting L equal 1.

K and L of large value will give more accurate estimation. However, it should be noted that the frequency offset that can be estimated must satisfy
MLTf₀<1 (10)
otherwise the e^{j2πMLf}^{₀}^{T} term in Equation (7) will wrap around and produce incorrect results.

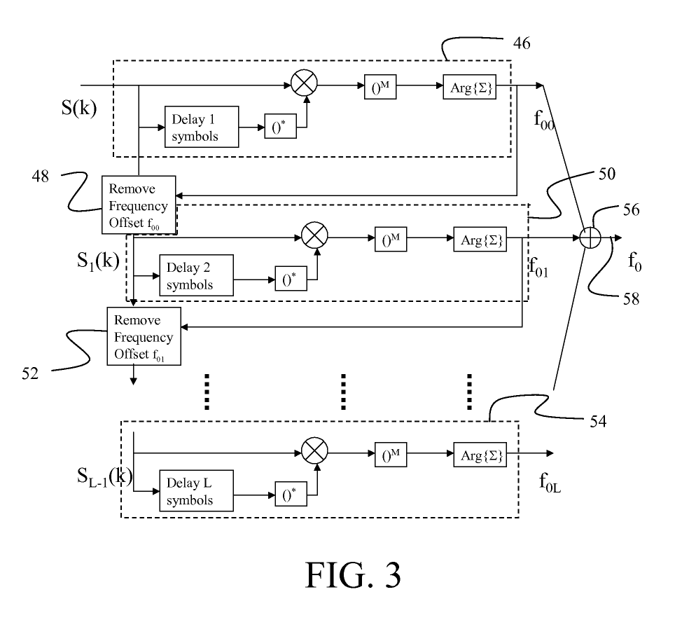

The frequency estimator of the present invention uses iterative structure as shown in FIG. 3. The received signal is processed through the first round of frequency estimation using the method as shown in FIG. 1 in an estimator 46 for L=1, which produces f₀₀, the first round of frequency offset estimation. S₁(k) is then generated by removing f₀₀ from the initial estimate S(k) in block 48. To be specific
S₁(k)=S(k)·e^{-j2πf}^{₀₀}^{KT} (10)

S₁(k) has a smaller frequency offset than S(k). Next, the residual frequency offset in S₁(k) is estimated based on a frequency estimator 50 again using the method steps to implement Equation (7) with L=2. The second iteration of the frequency estimator, as stated earlier, handles a narrower range of frequency offset but has higher accuracy. Expressing the method operation in equation form
S₂(k)=S₁(k)·e^{-j2πf}^{₀₁}^{KT} (11)

S₃(k) is then generated by removing f₀₂ from the second estimate S₂(k) in block 52. This set of process steps repeats until the required resolution of frequency estimation is reached.

The frequency offset range this iterative estimator is capable of estimating is

$${f}_{0} < \frac{1}{MT} \qquad ( 12 )$$

The accuracy is mainly determined by the last stage. Large L provides better accuracy.

The final estimator is shown representatively as element 54. The outputs of each iterative frequency offset estimator stages is summed 56 to provide the frequency offset estimate

$${f}_{0} = {\sum }_{i = 0}^{L - 1} {f}_{0 i} \qquad ( 13 )$$

as output 58.

For a practical implementation of this estimator, executing all the stages of estimation of 0, 1, . . . L−1, as shown in FIG. 3 is usually not required. Except the first and last stages, many of the stages 1, . . . L−2 can be skipped. For example, if the residual frequency offset in S₁(k) is bounded by fᵣ, all 1, . . . , Lᵣ−1 stages are skipped, provided MLᵣTfᵣ is much smaller than 1. For practical implementation purposes, an exemplary embodiment employs a test of

$${ML}_{r} {Tf}_{r} = \frac{1}{4} \qquad ( 14 )$$

and incrementing the estimation stage by Lᵣ for obtaining the next incremental frequency offset estimate.

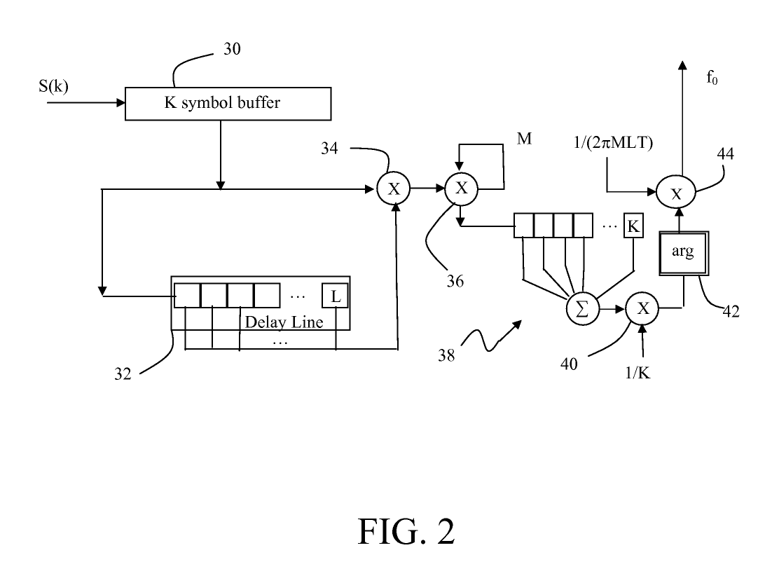

An implementation of the stages of the frequency offset estimator according to the present invention is shown in FIG. 2. The frequency offset estimator for MPSK demodulation includes a buffer 30 for receiving a stream of K symbols. A delay line 32 of L symbol lengths where L is greater than 1 is connected to the buffer and a multiplier 34 receives a first input from the buffer and a second input from the delay line. The output of the multiplier is raised to the M power using a multiplier string 36 and an accumulator 38 receives the result for K symbols. A 1/K multiplier 40 acts on the output of the accumulator and the argument of the output of the 1/K multiplier is determined as the frequency offset. For the embodiment shown, the argument function is obtained using a look-up table 42. A multiplier 44 on the output provides the required ½πMLT factor. The buffer symbol data is then adjusted by the frequency offset for demodulation of the symbol burst.

Compared with existing non-data-aided frequency estimators, this method is capable of providing high accuracy estimation if the frequency offset is relatively small. This frequency estimator is applicable to all wireless standards using MPSK modulation, such as PHS, CDMA, WCDMA, CDMA2000 and other Phase Shift Keying methodologies.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for non-data aided frequency offset determination for MPSK demodulation comprising the steps of:
a. setting a counter equal to 0;
b. receiving a stream of K symbols of value S(k);
c. providing the symbol stream to a tapped delay line of L symbols in length;
d. multiplying the symbol stream and an output of the delay line;
e. raising the output of the multiplier to the M power;
f. accumulating the result over K symbols;
g. determining the argument of 1/K times the accumulated result to determine the frequency offset; and,
h. multiplying the argument by ½πMLT to provide a frequency offset output to a summer;
i. removing the frequency offset output from an initial estimate S(k);
j. incrementing the counter and repeating steps c to i L times; and,
outputting the value of the summer as the final frequency offset.

2. A method as defined in claim 1 wherein the step of multiplying includes the step of obtaining the complex conjugate of the delayed symbols.

3. A method as defined in claim 1 wherein the step of incrementing the counter is accomplished by a predetermined value other than 1.

4. A method as defined in claim 3 wherein the value for incrementing the counter is variable and further comprises the steps of:
determining if MLᵣTfᵣ is much less than one where the residual frequency offset in the initial estimate S(k) is bounded by fᵣ; and
if so, setting a value for incrementing the counter to Lᵣ.

5. A method as defined in claim 4 wherein the step of determining if MLᵣTfᵣ is much less than one is defined as determining if MLᵣTfᵣ is equal to ¼.

6. A frequency offset estimator for MPSK demodulation comprising:
a counter;
means for receiving a stream of K symbols;
a delay line of L symbol lengths where L is greater than 1 connected to the receiving means, an output of the delay line responsive to the counter;
a multiplier receiving a first input from the receiving means and the output from the delay line as a second input;
means for raising an output of the multiplier to the M power to provide a result;
an accumulator receiving the result for K symbols;
a 1/K multiplier acting on an output of the accumulator;
means for determining the argument of an output of the 1/K multiplier;
a multiplier for ½πMLT times an output of the determining means as an offset increment;
means for subtracting the increment from the symbol input stream;
means for incrementing the counter; and,
a summer receiving the offset increment and providing a final frequency offset as an output.

7. A frequency offset estimator as defined in claim 7 wherein the means for determining the argument comprises a look-up table.
